(19) United States
(12) Patent Application Publication
(10) Pub. No.: US 2011/0268572 A1
(43) Pub. Date: Nov. 3, 2011

(54) HIDE-AWAY WINDMILL

(76) Inventor: Roger D. Wilson, Boise, ID (US)

(21) Appl. No.: 12/912,739

(22) Filed: Oct. 26, 2010

Related U.S. Application Data
(60) Provisional application No. 61/254,949, filed on Oct. 26, 2009.
(60) Provisional application No. 61/307,618, filed on Feb. 24, 2010.
(60) Provisional application No. 61/316,951, filed on Mar. 24, 2010.

(51) Int. Cl. F03D 11/04

(52) U.S. Cl. 416/142

(57) ABSTRACT

A hide-away windmill is exposed to the wind for use and covered or hidden for storage. In one version, the windmill has a support tower that is extendable and retractable within another housing. In another version, the windmill is inside another housing, and the walls or portions of the housing are movable to open up the housing to expose the windmill to the wind, for example, in a cupola-style housing with louvers or doors. In yet another version, the windmill is surrounded by an extendable and retractable housing, wherein, when the housing is fully retracted, the windmill extends beyond the housing to be exposed to the air and whatever wind is available, and, when the housing is fully extended, the windmill including its turbine blades is entirely or nearly entirely enclosed within the housing. The windmill may be repeatedly exposed to become operable, and repeatedly covered or hidden, not only to become inoperable, but also to be not visible, and protected from high winds, when not in use. The hide-away feature may be for aesthetic reasons, and/or for safety, security and structural reasons.

This application claims priority of Provisional Application Ser. No. 61/254949, filed Oct. 26, 2009, Provisional Application Ser. No. 61/307618, filed Feb. 24, 2010, and Provisional Application Ser. No. 61,316951, filed Mar. 24, 2010, the entire disclosures of which are incorporated herein by this reference.

### BACKGROUND OF THE INVENTION

1. Field of the Invention

This invention relates generally to windmills, especially windmills for generating electricity. More specifically, this invention relates to windmills which may be hid away during the day, for example, for aesthetic purposes, or hid away during high winds, for example, for safety and structural security purposes.

2. Related Art

U.S. Pat. No. 2,177,801 (Erren) discloses a windmill of the horizontal axis type which may be extended and retracted to reach an elevation of optimum wind speed.

U.S. Pat. No. 4,342,539 (Potter) discloses a windmill with a telescoping, rotating and tillable tower. The airfoils of this windmill are sails which fold together when the tower is retracted.

U.S. Pat. No. 6,442,936 (Van Guist, et al.) discloses a building cupola with a ventilator function.

U.S. Pat. No. 6,749,393 (Sosonkina) discloses a wind power plant in a rotatable housing for facing into the wind.

U.S. Published Application #2005/0005562 A1 (Henderson, et al.) discloses a telescoping support tower for a horizontal-axis windmill. When the support tower is fully extended, the tower sections are secured in fixed relative position by bolts.

U.S. Pat. No. 6,979,170 (Dery, et al) discloses a vertical-axis windmill with a telescoping support tower. When the support tower is fully extended, the lifting hydraulic jacks are removed, and the tower sections are fixedly secured in position.

U.S. Design Pat. No. D533,672, and U.S. Published Patent Application #U.S./2007/0107326 (Uffner, et al.) disclose a modular cupola design.

U.S. Pat. No. 7,215,037 (Scalzi) discloses an enclosed wind turbine with windward intake manifold which collects and concentrates the wind, and a leeward exhaust manifold.

U.S. Pat. No. 7,215,039 (Zambrano, et al.) discloses a wind turbine with a mounting assembly that attaches to an upper edge of a wall of a building to exploit an aerodynamically enhanced wind zone there.

U.S. Pat. No. 7,276,809 (Zambrano, et al.) discloses alternate embodiments of wind turbines for the invention disclosed in the '039 patent, discussed immediately above.

U.S. Patent Publication #2007/0284885 (Menges) discloses an enclosed wind turbine with wind directional apparatus that operates to adjust the speed of the wind and to channel the wind along a desired pathway towards the turbine.

U.S. Pat. No. 7,663,262 (Roskey) discloses a wind turbine between a pair of draw tubes for enhancing flow of wind to the turbine.

U.S. Published Patent Application #U.S./2010/0003136 (Anguelo) discloses a windmill tower supported by eight posts or tubing surrounded with a protecting strong mesh.

### SUMMARY OF THE INVENTION

The present invention is a hide-away windmill which is exposed to the wind for use and covered or hid for storage. In one embodiment, the windmill has a support tower which is extendable and retractable within another housing. In another embodiment, the windmill is inside another housing, and the walls, or portions of the walls, of the housing are movable to open up the housing, and expose the windmill to the wind. In yet another embodiment, the windmill is surrounded by an extendable and retractable housing. When the housing is fully retracted, the windmill of the present invention extends beyond the housing to be exposed to the air and whatever wind is available. When the housing is fully extended, the windmill, including its turbine blades, is substantially enclosed within the housing.

According to the present invention, the windmill may be repeatedly exposed to become operable, and repeatedly covered or hid, not only to become inoperable, but also to be not visible and protected when not in use. The hide-away feature may be for aesthetic reasons, and/or for safety, security and structural reasons.

### BRIEF DESCRIPTION OF THE DRAWINGS

FIG. 1 is a top, perspective, schematic view of two windmills according to embodiments of the present invention mounted on a house.

FIG. 2A is a sectional view of the view of FIG. 1, from the middle of the house and looking towards the left side in FIG. 1, wherein a sliding cover is provided over the space into which the windmill retracts. FIG. 2B is a view similar to that in FIG. 2A, but featuring a roof-top housing with a pivotal cover.

FIG. 3 is a sectional view of the view of FIG. 1, from the middle of house and looking towards the right side in FIG. 1.

FIG. 4A is a partial, perspective, detail view of one embodiment for securing the windmill blades of FIG. 1 in a specific position.

FIG. 4B is a partial, perspective, detail view of another embodiment for securing the windmill blades of FIG. 1 in a specific position.

FIGS. 5A-5E is a schematic, partial, side view of a progression in the process of another positioning and securing device for the windmill blades in FIG. 1.

FIGS. 6A-6E is a schematic, partial, cross-sectional view of a progression in the process of yet another positioning and securing device for the windmill blades of FIG. 1. FIG. 6F is a top view of the view depicted in FIG. 6E.

FIGS. 7A and 7B are partial, side, cross-sectional views of different embodiments for securing the support tower for the windmill within housings such as those depicted in FIG. 1, for example, wherein the securing structures hold the support tower upright in a wall space or chimney while also allowing vertical movement for telescoping extension and retraction.

FIGS. 8A and 8B is a schematic, cross-sectional view of a progression in the process of lowering another embodiment of the windmill of the invention behind a protective housing on a roof, for example.

FIG. 9A is a top, perspective, schematic view of a house with an embodiment of the present invention on the roof as a cupola.

FIGS. 9B and 9C are an elevation view and a plan, cross-sectional view, respectively, of an embodiment of the present invention for mounting on a roof as in FIG. 9A.

FIGS. 10A-10I are a collection of vertically arranged sets of schematic images, namely from bottom to top in the vertical set of images, namely, side-view with vents opened, side-view with vents closed, and plan cross-sectional view, of three different embodiments of the present invention for mounting on a roof that are similar to the embodiment in FIG. 9A-C.

FIG. 11 is a side view for the embodiment depicted in FIGS. 10A-C, but with flexible side panels that roll/slide up and down like a garage door.

FIG. 12 is also a side view for the embodiment depicted in FIGS. 10A-C, but with split side panels that open outward and close inward like a set of cabinet doors.

FIG. 13 is a schematic side view of another embodiment of the invention, atop a separate, self-standing support tower.

FIG. 14 is a schematic perspective view of an embodiment similar to that depicted in FIG. 13, but with a plurality of support towers integrated into a fence line.

FIG. 15A is a schematic, perspective view of another housing for an embodiment of the invention.

FIG. 15B is a side, cross-sectional view of the embodiment of FIG. 15A.

FIG. 16A portrays the embodiment of FIGS. 15A and B, with part of the housing retracted to expose the windmill.

FIG. 16B is a side-cross-sectional view of the embodiment of FIG. 16A.

FIGS. 17A is a schematic, perspective view of another housing for an embodiment of the invention, which is a modular housing that may be installed, for example, by stacking, connecting, and anchoring modules to a previously-built home to form a housing of appearance similar to that of FIG. 15A.

FIG. 17B is a side, cross-sectional view of the embodiment of FIG. 17A.

FIG. 18A portrays the embodiment of FIGS. 17A and B, with part of the housing retracted to expose the windmill.

FIG. 18B is a side-cross-sectional view of the embodiment of FIG. 18A.

FIG. 19 is a side, schematic view of the housing in the embodiment of FIGS. 17A and B, and 18A and B, disassembled for shipping, wherein the lower base unit remains generally intact, and the upper modules are broken-down into panels and stacked and strapped onto the lower base unit.

FIG. 20 is a schematic view of the housing of FIGS. 17A and B, 18A and B, and 19, but with the modules partially assembled.

FIGS. 21A-C are a set of partial, perspective views of an embodiment of the housing of the invention retracting in a progression in the process to expose the windmill.

FIG. 22 is a schematic, perspective view of an alternative housing embodiment, that is similar to, but shorter than, the embodiment depicted in FIGS. 21A-C, and that is mounted on a roof of a home.

### DESCRIPTION OF THE PREFERRED EMBODIMENTS

Referring to the Figures, there are disclosed several, but not all, of the embodiments of the present invention.

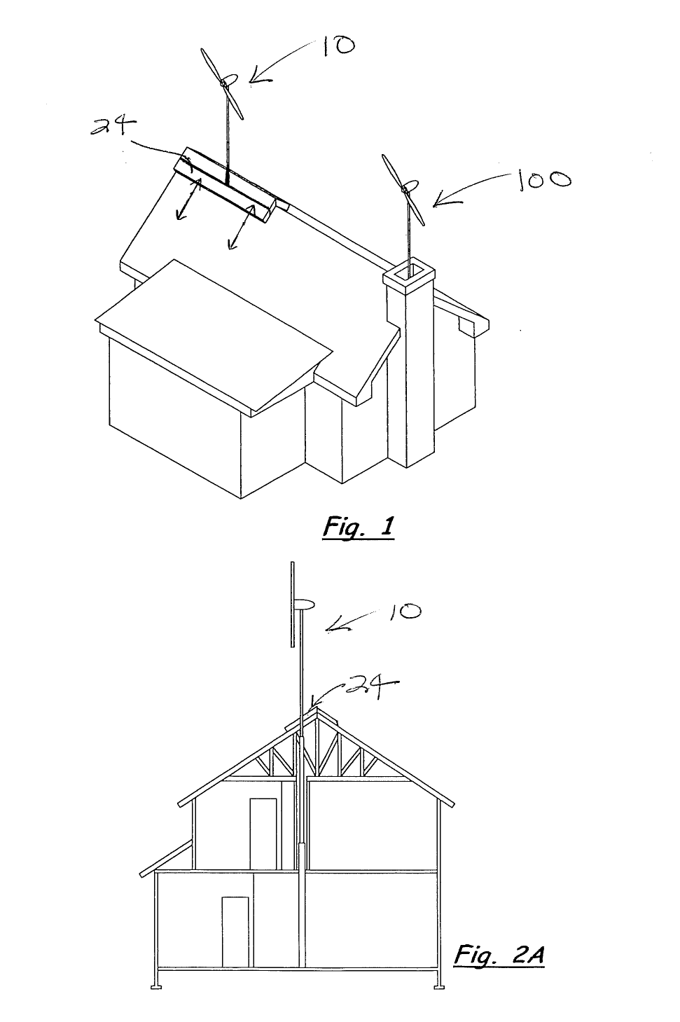

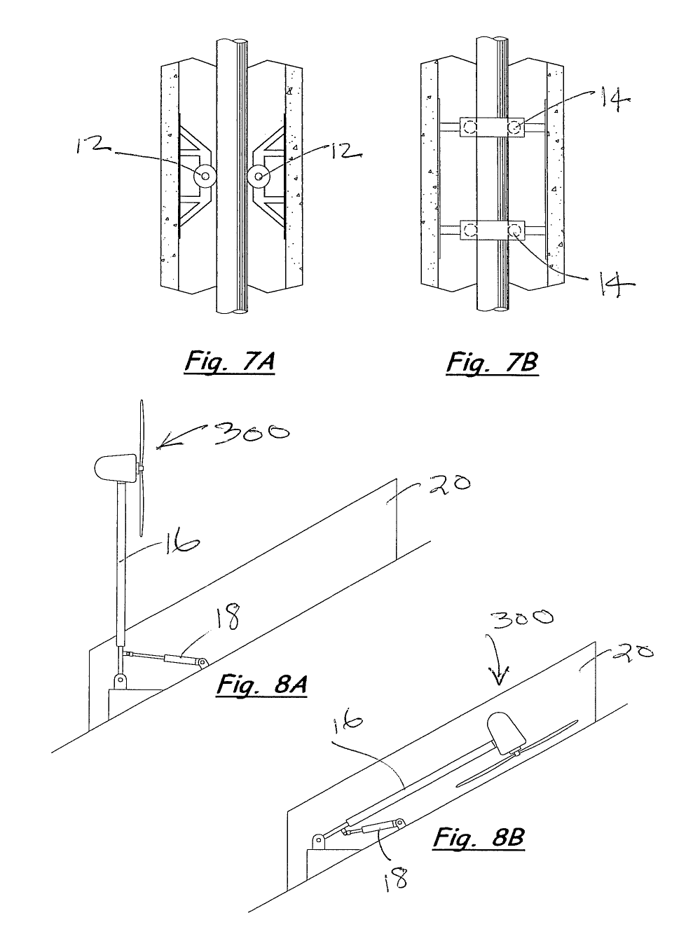

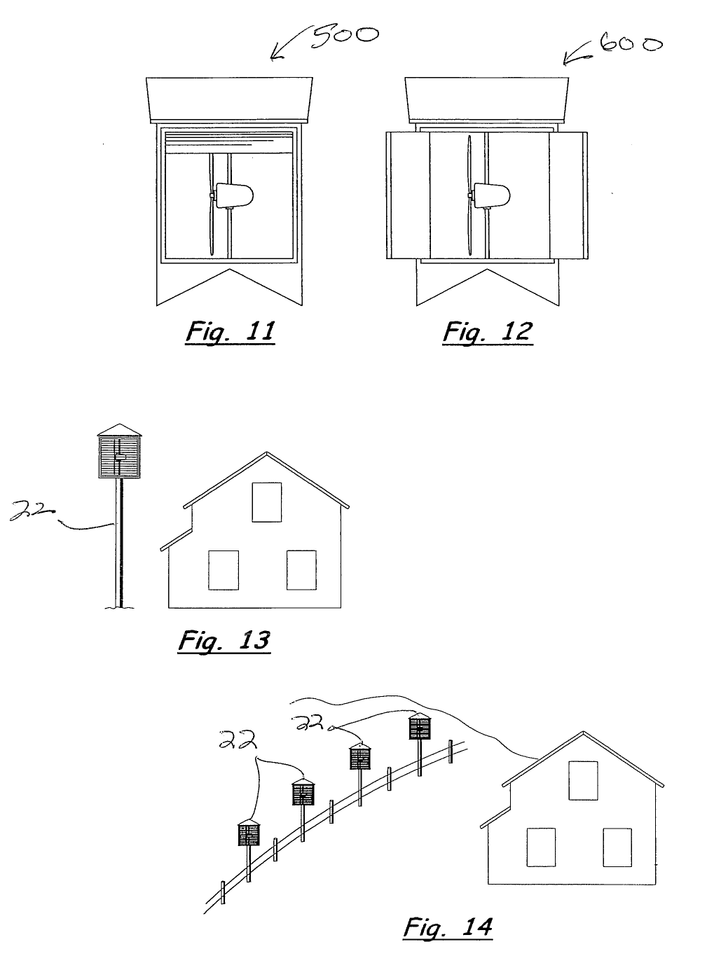

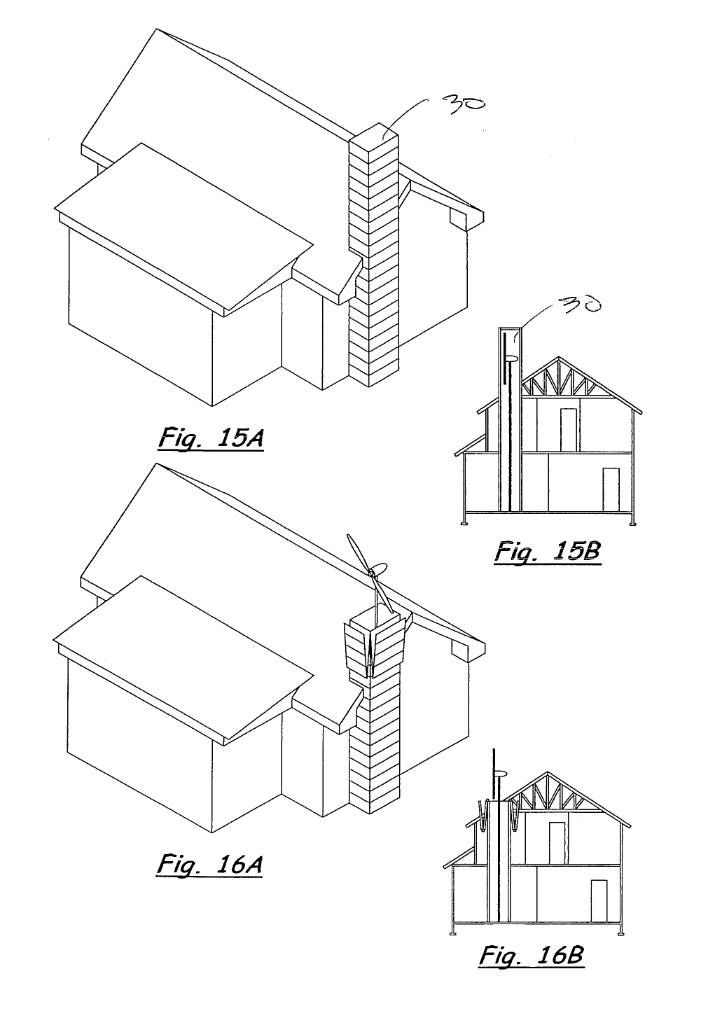

In FIG. 1 is disclosed a side perspective view of a home with a first and a second embodiment of the invention, 10 and 100, respectively. For the first embodiment, the home has a horizontal-axis windmill system 100 positioned within the chimney of the home. The preferred windmill may be described as comprising blades and preferably comprising the turbine that is adapted to convert rotational energy to electricity; many windmill blade and turbine designs may be used. The production, transmission, handling, and storage or use of the electricity will be understood by those of skill in the art, after viewing this disclosure. A side, cross-sectional detail view of the chimney-mounted windmill system 100 is depicted in FIG. 3. As therein depicted, the windmill system 100 has two (2) turbine blades and a telescoping support tower of several sections in an extended position. The base of the support tower is on the floor, or foundation, of the home. Optionally, the support tower sections may be additionally supported by brackets 12 or braces 14 within the chimney. The brackets or braces may be fixed to the telescoping sections of the telescoping support tower, and therefore movable relative to the inside walls of the chimney described herein as the “blade garage”. Or, the brackets or braces may be fixed to the inside walls of the chimney, or the “blade garage”, and therefore movable relative to the telescoping sections of the support tower, as depicted in FIGS. 7A and B. Also, the support tower 16 and windmill 300 may be supported on the roof of the house as depicted, for example, in FIGS. 8A and B. In this embodiment, the tower 16 with the windmill 300 may be supported vertically by a hydraulic ram 18 operation (FIG. 8A), and pivoted by the ram to be parallel with the roof and held there below the sides of a protective wall 20 (FIG. 8B), wherein the protective wall may lie on one side, or around multiple sides of the downwardly-pivoted windmill system. Also, the support tower 22 may be self-standing and self-supporting, as depicted in FIGS. 13 and 14.

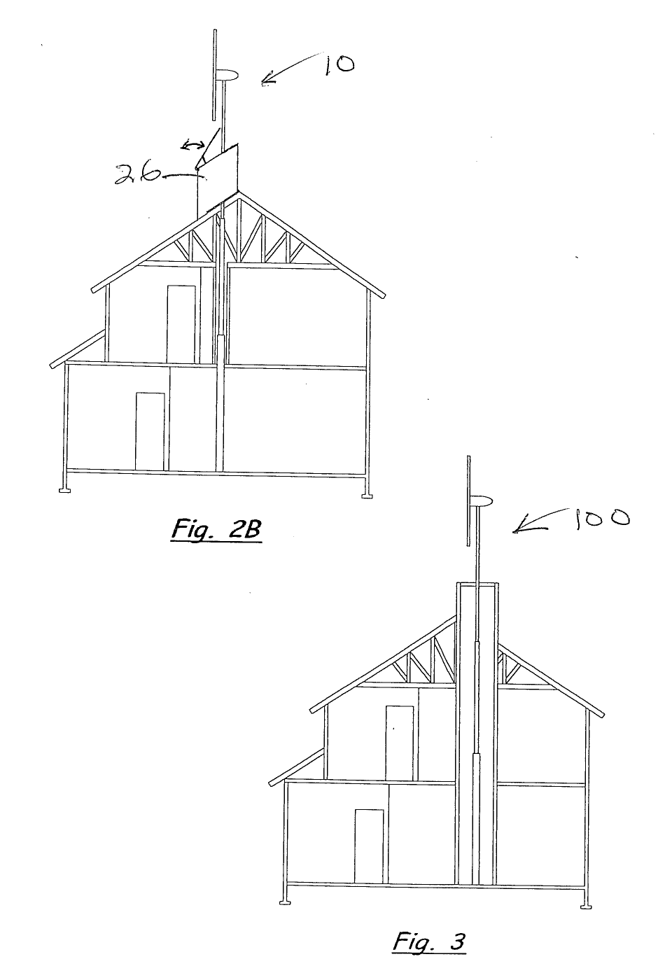

Also, the home in FIG. 1 has another horizontal-axis windmill system 10 positioned through a roof. A side, cross-sectional detail view of the through-roof mount version is depicted in FIGS. 2A and B. As therein depicted, the windmill system 10 has two (2) turbine blades and a telescoping support tower of several sections in an extended position. In this case, the base of the support tower is also on the floor or foundation of the home, with the support tower preferably extending up through the interior space of a wall and through the attic space. In FIG. 2A, a sliding or otherwise moveable door 24 on the roof may open and close for extension and retraction of the windmill blades and the upper portion of the support tower. In FIG. 2A, the windmill blades and support tower retract into the attic or other under-roof space in the home. In FIG. 2B, a portion or all of the windmill blades and an upper portion of the support tower may reside, when retracted, in a housing, or “blade garage”, provided on the roof. Such a roof-top housing may be, for example, a cylinder, a half-cylinder, box 26 , or other shape for shelter, optionally with a moveable lid, which housing is supported by the roof and/or supported as well by an upwardly-extending outside wall of the home. By providing a roof-top housing, a portion or all of the windmill and the upper portion of the support tower may be sheltered in said roof-top housing, for example, in the event that the attic or other under-roof space, and/or wall interior space, is not easily adapted to contain the entire windmill or portions of the windmill.

Because the support tower may be retracted within the chimney, home wall space and/or attic, or housing, it is easily protectable from high wind loads during storms, and therefore may be constructed of less robust materials and components than if it were not protectable, resulting in economy of construction. The support tower, with attached windmill blades, may be extended and retracted by any conventional means, including, for example, a hydraulic cylinder jack, a screwjack, and/or a series of pulleys and cables driven by electrical or hydraulic motors.

The turbine generator of the present invention may be of conventional, commercially available design, either horizontal or vertical axis. Likewise, the telescoping support tower of the present invention may also be of conventional structural tower design. In fact, the extendable/retractable support tower may be of the alternative conventional unfolding/folding type. Also, the support tower may even be a set of rails or runners on, for example, on an inner wall of the chimney, which rails or runners interact with a movable car on them, which car also carries the windmill turbine and blades for extending or retracting the windmill.

One feature of the present invention is to permit the windmill turbine and blades to be retracted enough to be substantially withdrawn within and concealed from view from the outside in the chimney or the roof-mounted “blade garage”. This way, the windmill turbine and blades, as well as the support tower, may be easily protected from excessively high winds. Also this way, the entire windmill may be substantially hidden within the chimney or “blade garage”, in order to maintain high quality aesthetics during the day, for example, when the windmill is in its retracted state, while still allowing the windmill to operate fully in its extended state at night when it is less likely to be “view clutter” for the neighbors, or public in general.

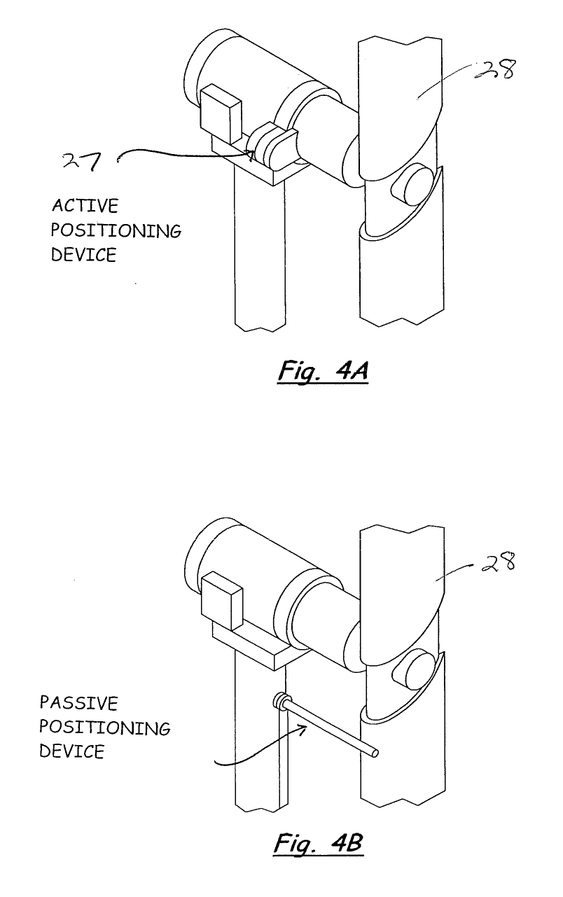

The blades of the windmill of the present invention may also be of conventional design. There may be two (2), three (3), four (4) or five (5) blades present. The blades may be fixed or foldable, also according to conventional design. Also, the blades may cooperate with the support tower for the turbine in an active or passive manner. Actively, the position of one or more blades when the windmill is in its retracted position may be controlled with power input. For example, as depicted in FIG. 4A, a brake plus controller 27 (“active positioning device” in the Figure) may act on the horizontal turbine axis, or a blade itself, and mechanically position the blade 28 so that it rests, and is secured, in a particular position. This way, as depicted in FIG. 4A, the blade may be securely positioned in a known orientation so it, plus the turbine and the support tower, may be effectively lowered and hidden away within the chimney or “blade garage”.

Also, as depicted in FIG. 4B, a brake plus a passive positioning device 29, which may be a simple rod unfolding outward and extending into the rotational path of the blade (when windmill is stopped), for example, may be used to position and orient the blade for retraction of the windmill into the housing.

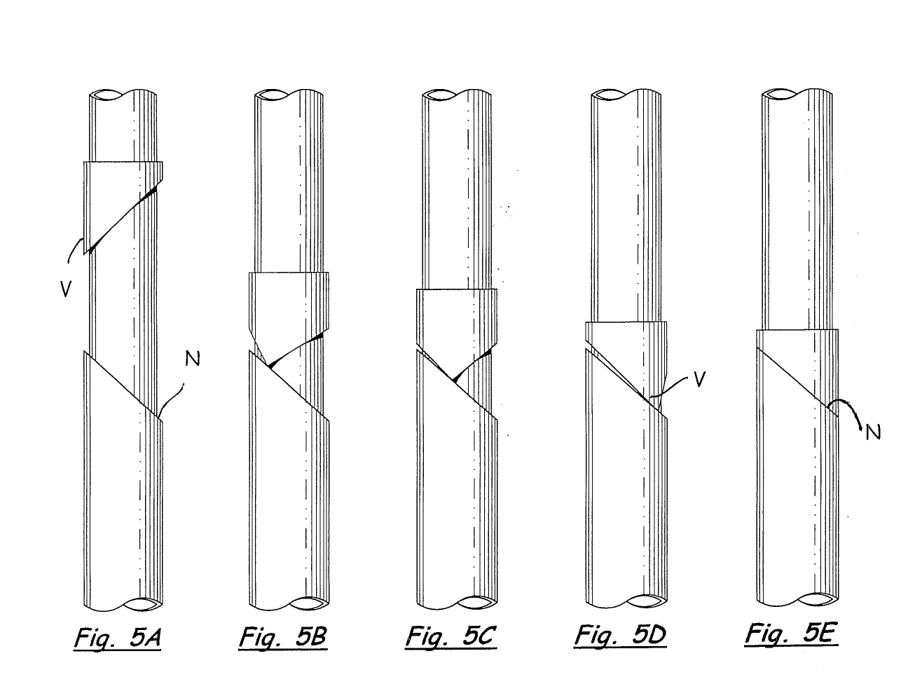

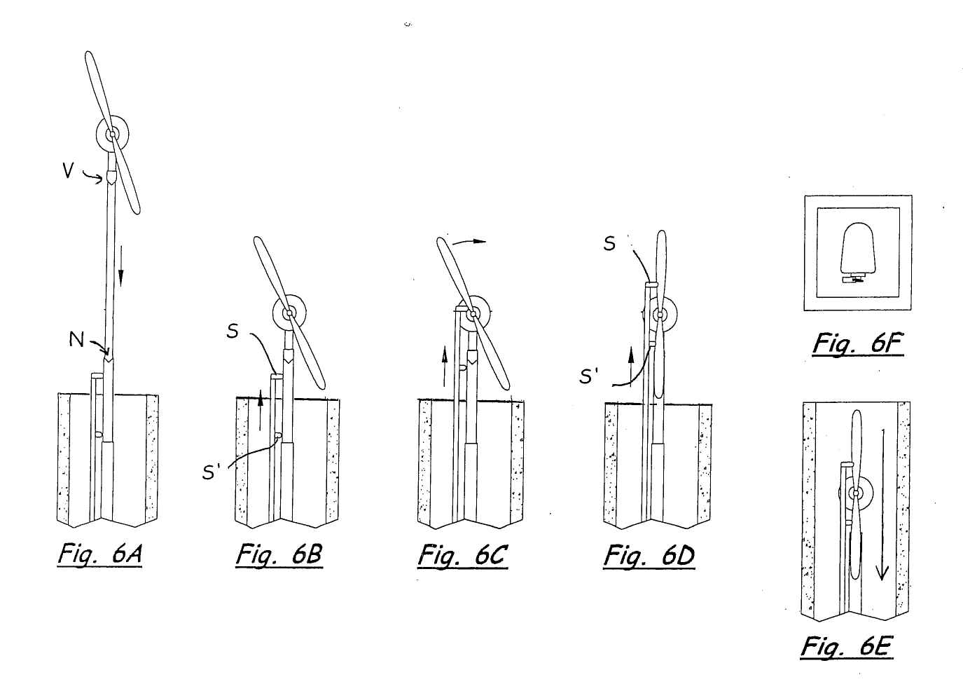

Another passive type positioning device, in this case two (2) cooperating slanted collars on a section of the telescoping support tower, is depicted in FIGS. 5A-5E. In addition, a combination passive type positioning device and active type securing device for the blade is depicted in FIGS. 6A-6E. In FIG. 6A, the windmill was extended and able to be turned by the wind, and the windmill is being lowered so that a v-projection near the top (seen as item “V” in FIG. 6A), begins to be lowered within a notch (seen as “N” in FIG. 6A) near the bottom, as in FIG. 6B. Then, after the windmill is lowered to the extent that v-projection “V” is fitted within notch “N”, blade stops “S” and “S′” are raised into place (FIG. 6C and D) to orient and secure the lowered turbine blades in a fixed position that is shown to best advantage in FIGS. D and F. FIG. 6E portrays how the support tower may be further retracted, for example by telescoping action, deeper into the housing/chimney for complete or near-complete sheltering of the windmill and support tower.

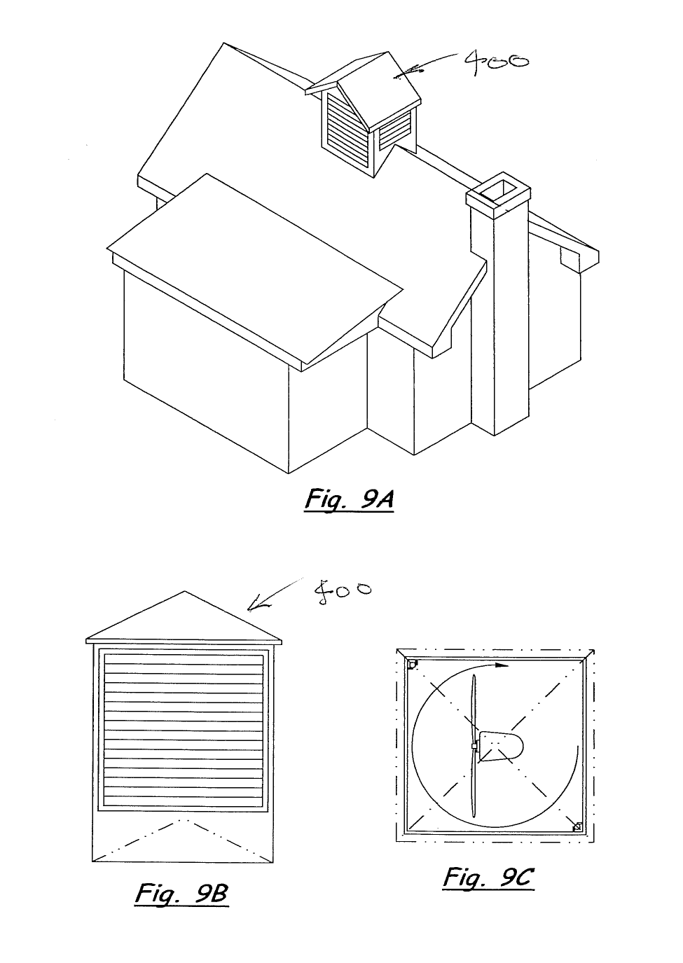

In FIG. 9A is disclosed a top, side perspective view of a house with an embodiment of the present invention on the roof as a cupola. The invention is a hide-away windmill inside the cupola 400. The side walls of the cupola are movable to open and close the enclosure. The cupola side walls may be horizontal or vertical louvers which rotate about their long axis to open and close the enclosure. Or, the cupola side walls may fold near their middle to move up, down, or sideways like airplane hangar doors, to open and close the enclosure. Or, the cupola side walls may rotate about an edge to swing up, down, or sideways to open and close the enclosure. Or, the cupola side walls may slide up, down, or sideways to open and close the enclosure. Clearly, the cupola side walls may open and close in any of many conventional ways. Currently, the inventor prefers the horizontal louver approach indicated in the figures.

The cupola may be secured to the house in any conventional manner. The Uffner, et al. set of references discussed above, for example, discloses a base for the cupola which may be adjusted to fit the different pitches of different roofs.

Also, the enclosure of the present invention may exist in other embodiments besides being on the roof of a building. For example, the enclosure may perch at or near the top of a pole or slender tower, and be integrated with a light and/or advertising sign. Or, the enclosure may hang in an open patio, and be integrated with a planter or a bird cage, for example. Or, the enclosure may hang from the branch of a tree, or from a clothesline, or even from a power line if adequately insulated. Or, the enclosure may be on a platform on a stand which is tipped up to lean against and be secured to a building wall or chimney or light pole or telephone or power pole. See, for example, FIGS. 13 and 14. Clearly, the enclosure may be elevated to be exposed to the wind in any of many conventional ways.

In FIG. 9B is disclosed an elevation view of one embodiment of the present invention wherein the enclosure is a cupola for a roof. The cupola has flat side walls with horizontal louvers which rotate about their horizontal axes to open and close the side walls of the enclosure. This way, when the wind blows it may enter the open side walls of the cupola, and power the turbine inside the enclosure. Optionally, as depicted in FIG. 9C in a plan, cross-sectional view, the turbine inside the enclosure may rotate so it is facing the optimum direction relative to the wind direction. Also, optionally, some of the side walls of the enclosure may be selectively opened, and others selectively closed, again to provide optimum fluid dynamics for the particular wind direction and velocity being experienced. In this vein, an electric/electronic controller, for example, may be used to sense wind direction and velocity, and optimally position the turbine, and also optimally position the enclosure side wall louvers for the given wind direction and velocity. Of course, mechanisms for hand operation may also be provided for orienting the turbine, and for positioning the louvers of, or the side walls themselves, for optimal efficiency based upon the operator's knowledge and experience. Also in this vein, the size and shape of the louvers may be selected to optimize not only their opening and closing features, like size of opening and tightness of closed seal, but also to optimize their wind collecting and guiding features, like baffles, chutes, and funnels.

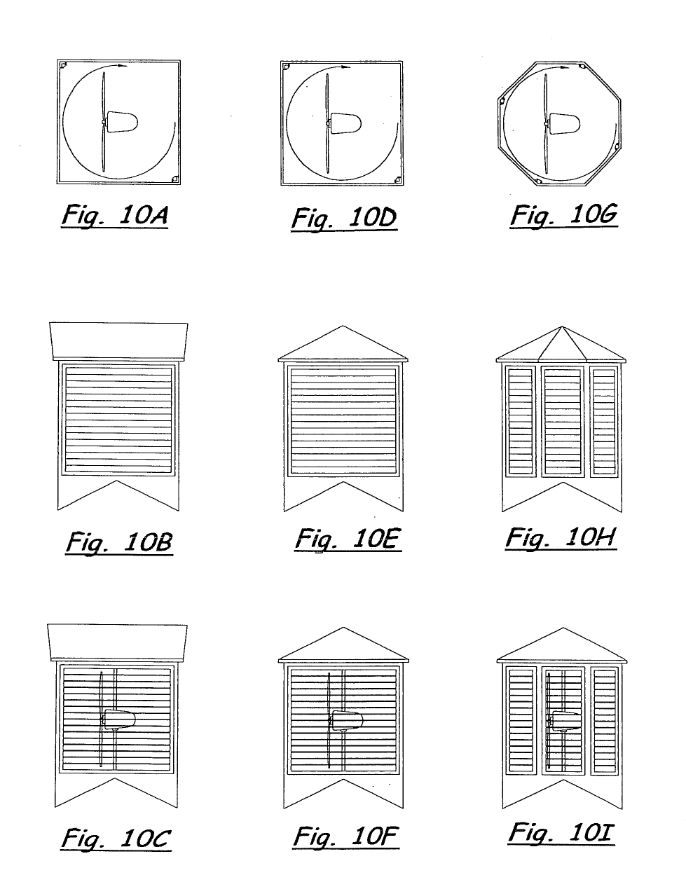

FIGS. 10A-I are a collection of vertically arranged sets of images for three embodiments of vented housings, namely, a “dormer” style (FIGS. 10A-C), a “square” style (FIGS. 10D-F), and an “octagon” style (FIGS. G-I). From top to bottom, the views are: top cross-sectional view (FIGS. 10A, D, G), side-view with vents closed for sheltering the windmill (FIGS. B, E, H) and side-view with vents open for wind access to the windmill blades (FIGS. 10C, F, I).

The turbine generator of the present invention may be of conventional, commercially available design, either horizontal or vertical axis. The blades of the windmill of the present invention may also be of conventional design. There may be two (2), three (3), four (4) or five (5) blades present. Also, the windmills of the present invention may be multiple per location, that is, several enclosures on a roof, each containing a turbine, for example, or even several turbines within an enclosure. Multiple windmills may be connected together in parallel or series regarding their electrical generating capabilities.

FIG. 11 depicts another embodiment of a cupola windmill system 500 of the present invention, with side panels being able to roll or slide up to open and expose the windmill to the wind. When it is desired to cover or hide the windmill from the wind, the covers likewise roll or slide down and protect the windmill from the wind. FIG. 12 depicts another embodiment of the cupola windmill system 600 of the present invention, with split side panels being able to swing out to open the windmill to the wind, and likewise being able to swing inward to close the windmill to the wind.

FIG. 13 depicts a cupola version of the present invention perched atop a self-standing, separate support tower 22. FIG. 14 depicts a cupola version of the present invention perched atop a plurality of self-standing, separate support towers, integrated into a fence line.

In FIG. 15A is disclosed a side perspective view of one embodiment of the hide-away windmill of the present invention attached to the side of a house with the windmill enclosed within a closed enclosure. The closed enclosure in this embodiment looks like a chimney attached to the house, with siding and other architectural details to help it fit in aesthetically with the house design.

However, as depicted in a side cross-sectional view in FIG. 15B, instead of a chimney, the closed enclosure is a tower 30 which surrounds and hides away a windmill on a vertical support. This way, the windmill may be hid away, for aesthetic purposes, for example, when it is not desirable or optimal for the windmill to be operable. For example, neighborhood conditions, covenants and restrictions (“C, C & R's”) may not allow the windmill to be visible during the day. This invention, then, may allow for a windmill to be installed, and be operable for at least part of the time, and still not violate any C, C & R's. Also this way, the windmill may be hid away during times dangerous for its mechanical of structural integrity or safety. For example, during high winds or rain, snow or ice storms, the windmill of the present invention may be wisely hid away to protect it from the elements. In this regard, the enclosure may be moved to only partially open and only partially expose the windmill to the wind. This way, the shroud of the enclosure may also act as part of a control device opening more, but not all the way to let more wind at the windmill, or closing more, but again not all the way, to let less wind at the windmill. In this alternative embodiment, the enclosure should may be optimally operatively connected to conventional sensing, logic and controllable actuation elements to controllably affect the adjustment of the enclosure shroud. For example, conventional wind velocity and direction sensing devices may be employed. Also, conventional position sensing devices for detecting the movable parts of the enclosure shroud may also be employed.

During the night, or at any other time it is desired to operate the windmill, the enclosure around it may be moved out of the way to expose it to the then available wind. The enclosure may be moved to open or close in any conventional way. For example, the top panels of the tower which supports the windmill may fold, slide or swing down to move out of the way to open up and expose the windmill to the wind. As depicted in FIGS. 16A and B, the enclosure shroud in the pictured embodiment folds down to expose the windmill. In other, non-pictured embodiments, the enclosure shroud may swing or rotate down to expose the windmill, or up to enclose it.

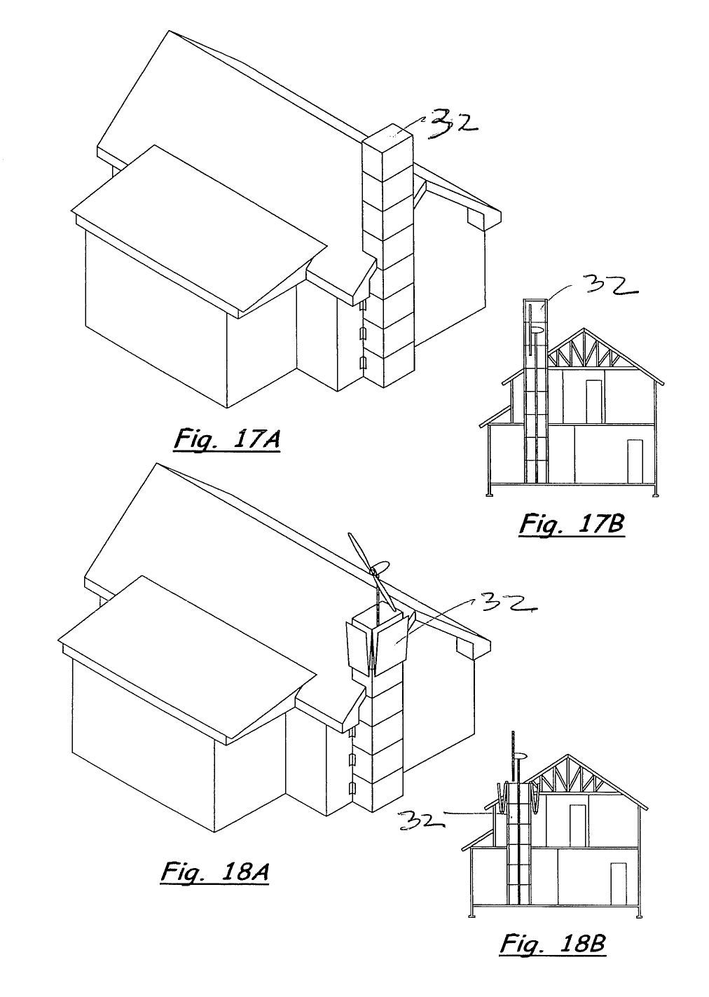

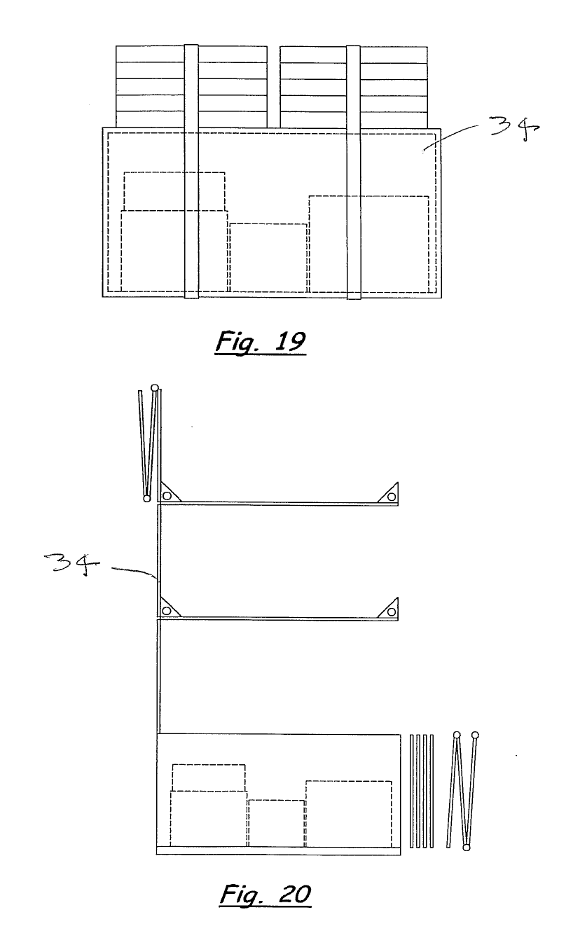

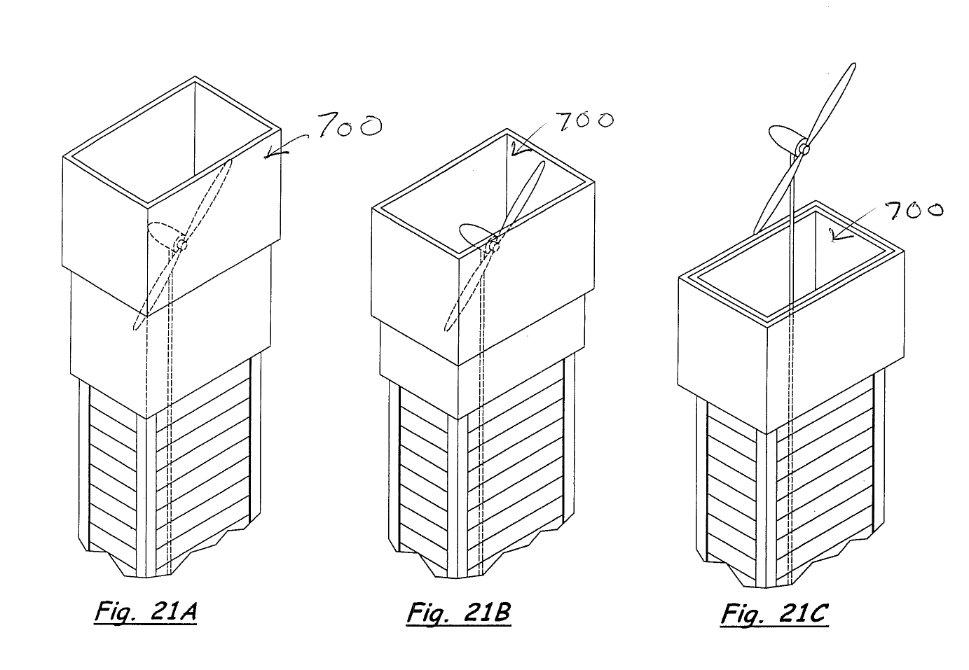

As depicted in FIGS. 17A and B, the housing 32 for the windmill may be provided in a retrofit version that is provided as a separate structure connected to the side of a house, typically but not necessarily at a date later than the construction of the house. This retrofit version may optionally be built from modules, as discussed later in this document. As depicted in FIGS. 18A and B, the retrofit and/or modular housing for the windmill may have top panels/portions that fold or swing down at the top to expose the windmill.

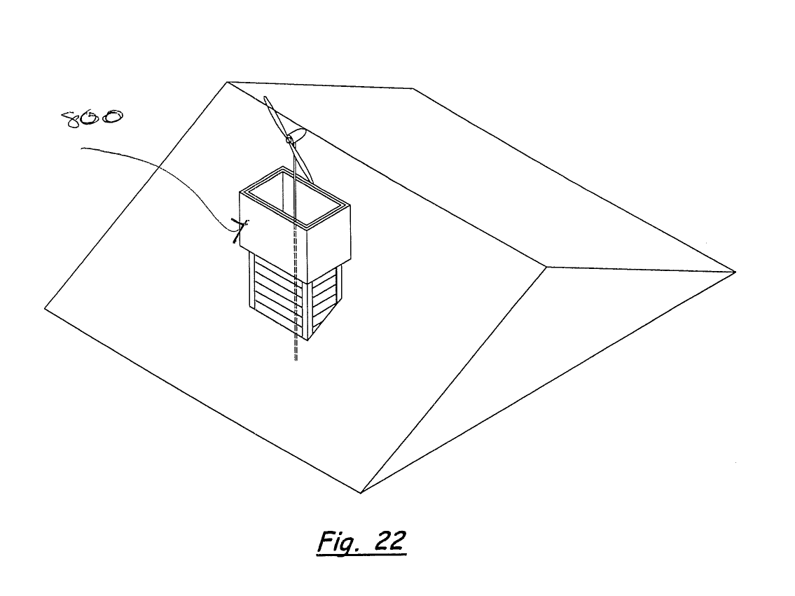

In FIG. 19A is disclosed a side, cross-sectional view of a modular support tower 34 for one embodiment of the invention. This modular tower is comprised of multiple panels which are preferably packed flat for ease and economy during shipping. For the base of the tower, a box-like enclosure containing the electrical components for the generating station powered by the windmill at the top of the tower is provided. For example, the box enclosure at the base of the tower may contain a pre-assembled and connected battery, DC/AC voltage converter, and electrical control and monitor instruments (portrayed in dashed lines in FIGS. 19 and 20). This way, for a homeowner, for example, one embodiment of the present invention may be conveniently unpacked, assembled, erected and hooked up to the home's electrical system with as few as one or two wires.

On the top of the pre-assembled box base, a series of securely interconnecting panels may be assembled and erected to form the modular tower of the present invention. The panels may be as simple as a series of interconnected tubular risers and struts. Or, the panels may also be box-like enclosures made of solid walls. Individual panels may be bolted, screwed, snapped or welded together. On top of the top panel, for example, the folding enclosure of FIGS. 18A and B may be placed.

In FIGS. 21A-C are disclosed different views of another embodiment of the present invention. This embodiment is a slide-type enclosure which slides down to open, and slides up to close around the windmill. In these Figures, the enclosure has no top lid or cover. However, a top, which, for example, is comprised of two panels, each pivotally connected to a top inside edge of the enclosure which panels fold up to close the top of the enclosure when it is in its raised position. As is depicted in the Figures, the slide-type enclosure slides down to expose the windmill to the wind, and slides up to protect it from the wind.

The sliding enclosure depicted in FIGS. 21A-C may be placed on the top of a modular tower such as that depicted in FIGS. 18A and B (in place of the folding/swinging top). The modular tower may be free standing or installed next to, and even supported by, a building like the house depicted in FIGS. 17A and B, and 18A and B.

Also, the sliding enclosure depicted in FIGS. 21A-C may be placed on or near the roof of a building, like a cupola, for example.

In FIG. 22 is depicted a version of a slidably-retracting housing version 800, with sliding top panel systems similar to those in FIGS. 21A-C except that the housing is much shorter for attachment to the top surface of a roof.

The enclosure of the present invention may be extended and retracted by any conventional means, including, for example, a hydraulic cylinder jack, a screwjack, and/or a series of pulleys and cables moved manually, or driven by electrical or hydraulic motors.

Although this invention has been described above with reference to particular means, materials and embodiments, it is to be understood that the invention is not limited to these disclosed particulars, but extends instead to all equivalents within the scope of the following claims.

I claim:

1. A hide-away windmill that is extendible for use and retractable for storage, comprising:
a support tower for the windmill, which tower is extendible and retractable;
the support tower being extendable beyond a housing that surrounds the support tower, and the support tower being retractable to be within the housing.

2. The hide-away windmill of claim 1 wherein the windmill comprises a blade that is secured in a selected position when the support tower is retracted within the housing.

3. A hide-away windmill system inside an enclosure, the windmill system comprising:
a windmill; and
an enclosure with walls that surround the windmill, the walls of the enclosure being movable to open up the enclosure and expose the windmill to the wind, and the walls of the enclosure also being movable to close the enclosure and protect the windmill from the wind.

4. The hide-away windmill system of claim 3, wherein the enclosure is a cupola on the roof of a house.

5. The hide-away windmill system of claim 4, wherein the movable walls are louvers that each move about a horizontal axis to open and close.

6. The hide-away windmill system of claim 4, wherein the windmill rotates around a vertical axis to point into the best wind conditions within the cupola.

7. A hide-away windmill system comprising:
a windmill; and
an extendable and retractable housing, the housing surrounding the windmill when the housing is in its extended state, and the housing not surrounding the windmill when the housing is in its retracted state.

8. The hide-away windmill system of claim 7, wherein a positioning device secures a blade of the windmill when the windmill is surrounded by the housing.

9. The hide-away windmill system of claim 7, wherein the windmill and the moveable enclosure are both installed at or near the top of a modular tower.

10. The hide-away windmill system of claim 9, wherein the modular tower is assembled from a set of multiple panels that form sides of the modular tower.

11. The hide-away windmill system of claim 7, wherein the housing retracts by at least one top portion of the modular folding downward.

12. The hide-away windmill system of claim 7, wherein the housing retracts by at least one top portion of the modular tower sliding downward over a lower portion of the modular tower.
